(19) United States
(12) Patent Application Publication
(10) Pub. No.: US 2026/0001810 A1
(43) Pub. Date: Jan. 1, 2026

(54) SYSTEM AND METHOD FOR CONSTRUCTION MATERIAL

(71) Applicant: Purdue Research Foundation, West Lafayette, IN (US)

(72) Inventors: Jeffrey Youngblood, Crawfordsville, IN (US); Pablo Zavattieri, West Lafayette, IN (US); Jan Olek, West Lafayette, IN (US); Yu Wang, Lafayette, IN (US)

(21) Appl. No.: 19/253,199

(22) Filed: Jun. 27, 2025

Related U.S. Application Data
(60) Provisional application No. 63/666,477, filed on Jul. 1, 2024.

(51) Int. Cl. C04B 2/02; C04B 7/02; C04B 16/06; C04B 28/06; C04B 111/00

(52) U.S. Cl. CPC C04B 2/02; C04B 7/02; C04B 16/06; C04B 28/065; C04B 2111/00181

(57) ABSTRACT

This disclosure relates to cementitious systems that are useful in the chemical arts, such as in the manufacture of products, such as construction materials. In particular, the present disclosure relates to compositions and methods for preparing certain cementitious systems, such as compositions including a cementitious material, limestone, and cellulose nanofibers (CNFs).

### RELATED APPLICATIONS

This application claims the benefit of U.S. Provisional Application No. 63/666,477, filed Jul. 1, 2024, the entire disclosure of which is incorporated herein by reference.

### GOVERNMENT RIGHTS

This invention was made with government support under 69A3552348333 and 69A3552348339 awarded by the US Department of Transportation. The government has certain rights in the invention.

### TECHNICAL FIELD

The disclosure generally relates to construction materials and, more particularly, to cementitious systems. In particular, the present disclosure relates to compositions and methods for preparing certain cementitious systems, such as compositions including a cementitious material, limestone, and cellulose nanofibers (CNFs).

### BACKGROUND

Climate change poses a global challenge, primarily driven by elevated levels of carbon emissions and energy consumption. The construction industry plays a major role in this issue. Cement and concrete production alone account for approximately 8% of global human-made CO₂ emissions. With the anticipated growth of the urban population, the environmental impact of construction activities is projected to increase, underscoring the urgent need for more sustainable construction practices. 3D-printed (3DP) concrete is an innovative technique that has attracted attention for its potential to revolutionize traditional construction methods. Key advantages of 3D printing include the acceleration of the construction process, the elimination of formwork requirements, reduction in material waste, and improvements in mechanical performances through innovative designs that are otherwise difficult to achieve with conventional methods.

While 3DP concrete has the potential to advance sustainable and efficient construction practices, its sustainability is constrained by material development challenges, particularly those related to rheological properties, environmental impact, and cost efficiency. Commercially available 3DP concrete is about 5 to 8 times more expensive than conventional concrete, and its carbon footprint is 1 to 2 times higher. The extensive use of cement, lack of coarse aggregates, and heavy use of admixtures and additives make current printable concrete both unsustainable and cost-inefficient. Achieving superior rheological properties to print complex structures with large overhangs remains a persistent challenge in the field. Fresh concrete for 3DP requires a balance of rheological properties: high yield stress after extrusion to ensure buildability, moderately low viscosity during extrusion to enable smooth pumpability. These two properties are often in conflict. Current approaches to modifying the rheological performance of 3DP concrete involve using supplementary cementitious materials, chemical admixtures, and nanomaterials. However, a major limitation of these additives is their coupled effect on rheological properties: those that increase yield stress often also substantially raise viscosity, compromising pumpability. While this issue might be addressed by adding accelerators in the extruder's nozzle (a method known as the 2K-system in the field), this approach requires an additional accelerator pump and a specialized extruder to ensure the accelerator is homogeneously mixed. Furthermore, excessive accelerator use can compromise durability and mechanical properties, often exacerbating shrinkage (which is already a main issue in 3DP concrete), increasing corrosion risk, and reducing sulfate resistance. Overall, this method tends to be costly and less sustainable. These challenges hinder the progress of 3D printing technology in enhancing the sustainability of construction. Therefore, identifying innovative multi-functional additives or material combinations that can balance the demanding and often contradictory rheological properties requirements, and developing more cost-effective and environmentally sustainable printable mixtures, are crucial for the future of 3DP concrete.

Accordingly, 3D-printed (3DP) concrete requires demanding rheological properties to ensure successful printing. Thus, there is a need for printable concrete that is effective in balancing performance, sustainability, and cost-effectiveness due to stringent rheological requirements, high cement content, and extensive use of additives.

### SUMMARY

In one aspect, the present disclosure provides a composition comprising: a binder comprising a cementitious material and limestone, and a plurality of cellulose nanofibers (CNFs). The binder may include at least about 15% limestone by weight of the binder. The composition may include about 0.01% to about 1% CNFs by weight relative to the binder.

In another aspect, the present disclosure provides a mortar comprising: a binder comprising a cementitious material and limestone, a plurality of cellulose nanofibers (CNFs), sand, and water.

In another aspect, the present disclosure provides a multilayer structure comprising: a first layer and a second layer, wherein each of the first layer and the second layer independently comprises: a binder comprising a cementitious material and limestone, a plurality of cellulose nanofibers (CNFs), optionally sand, and water; and
wherein the second layer is arranged to be in contact (e.g., direct contact) with the first layer.

In yet another aspect, the present disclosure provides a method of making a structure, the method comprising the steps of:
extruding a mortar through an extruder to provide an extrudate, wherein the mortar comprises: a binder comprising a cementitious material and limestone, a plurality of cellulose nanofibers (CNFs), sand, and water; and
depositing the extrudate onto a surface to provide the structure.

Additional embodiments, features, and advantages of the disclosure will be apparent from the following detailed description and through practice of the disclosure. The compounds, compositions, and methods of the present disclosure can be described as embodiments in any of the following enumerated clauses. It will be understood that any of the embodiments described herein can be used in connection with any other embodiments described herein to the extent that the embodiments do not contradict one another.

### BRIEF DESCRIPTION OF THE DRAWINGS

The detailed description particularly refers to the accompanying figures.

FIGS. 1A-1D show isothermal calorimetry results for binders containing different CNF additions and LF replacement levels. FIG. 1A shows the results of heat flow measurement (the induction and acceleration periods estimated based on the results of PLC mixtures). FIG. 1B shows the results of total heat of hydration measured over 100 hours. FIG. 1C shows the first 15 hours of heat flow measurements from isothermal calorimetry results for PLC-LF0, PLC-LF14, and PLC-LF29 without CNF. FIG. 1D shows the first 15 hours of heat flow measurements from isothermal calorimetry results for PLC system with CNF additions of 0%, 0.15%, 0.3%, and 0.5% by weight.

FIG. 2 shows the rheological protocol used to measure the static yield stress, dynamic yield stress, critical strain, viscosity, and storage modulus of the cement paste materials (without sand).

FIGS. 3A-3E show rheological properties for mixtures with different CNF additions and LF replacement levels. FIG. 3A shows static yield stress results for PLC (11LF) and PLC-LF29 (40LF) with different CNF additions. FIG. 3B shows dynamic yield stress results for PLC (11LF) and PLC-LF29 (40LF) with different CNF additions. FIG. 3C shows storage modulus results for PLC (11LF) and PLC-LF29 (40LF) with different CNF additions. FIG. 3D shows critical strain results for PLC (11LF) and PLC-LF29 (40LF) with different CNF additions. FIG. 3E shows dynamic viscosity results for PLC (11LF) and PLC-LF29 (40LF) with different CNF additions.

FIGS. 4A-4C show rheological properties for mixtures with different CNF additions and LF replacement levels. FIG. 4A shows static yield stress versus viscosity for mixtures with different CNF additions and LF replacement levels. PLC-LF0 mixtures are indicated by squares and PLC-LF29 mixtures are indicated by circles. FIG. 4B shows shear stress as a function of shear rate during the hysteresis loop test for PLC with CNF additions of 0%, 0.15%, and 0.3%. Dark lines and light lines represent the increasing and decreasing strain rate segments of the hysteresis loop, respectively. FIG. 4C shows shear stress as a function of shear rate during the hysteresis loop test for PLC-LF-29 with CNF additions of 0%, 0.15%, and 0.3% by weight. Dark lines and light lines represent the increasing and decreasing strain rate segments of the hysteresis loop, respectively. FIG. 4D shows a graph of 3D-printed structures with an approximately 45-degree overhang, demonstrating improved extrudability and buildability due to the synergistic effects of CNF and LF.

FIGS. 5A and 5B show rheological results of the hysteresis loop tests. FIG. 5A shows shear stress as a function of shear rate during the hysteresis loop test for PLC0-LF100-CNF0.3 mix with a LF-to-water ratio of 0.4 and CNF addition of 0.3 wt. %. Dark lines represent the results of the increasing strain rate segment of the hysteresis loop, while light lines represent the results of the decreasing strain rate segment of the hysteresis loop. FIG. 5B shows shear stress as a function of shear rate during the hysteresis loop test for a comparison of the PLC0-LF100-CNF0.3 mix with the PLC-LF0 mixes. Dark lines represent the results of the increasing strain rate segment of the hysteresis loop, while light lines represent the results of the decreasing strain rate segment of the hysteresis loop.

FIGS. 6A-6D show large-scale 3D printing results for a complex overhang structure. FIG. 6A shows a schematic of the 3D printing system operation, comprising, a robotic arm (an ABB IRB 6700 robot arm), an IRC5 controller, a mortar pump, and an extruder with shear mixing capability. FIGS. 6B-6D show the appearance of the 3D-printed structures at the maximum buildability layer (top) and after structural failure (bottom). FIG. 6B shows the structure printed using the PLC-LF29-CNF0.3 mixture of the present disclosure, demonstrating a buildability of 78 layers, printed with two batches of material prepared approximately 15 minutes apart. FIG. 6C shows 3D-printed elements using a commercially available mixture from a cement company and the buildability of 18 layers with commercial material #1. FIG. 6D shows 3D-printed elements using a commercially available mixture from a cement company and the buildability of 8 layers with commercial material #2.

FIGS. 7A and 7B show mechanical properties of mortar specimens. FIG. 7A shows 28-day compressive strength of cast cubes (50 mm by 50 mm by 50 mm) under air-curing conditions. FIG. 7B shows 7-day flexural strength of 3D-printed beams (30 mm by 36 mm by 170 mm) under air-curing conditions.

FIGS. 8A-8C show thermal gravimetric analysis (TGA) of mortar specimens air-cured for 28 days. FIG. 8A shows TGA results showing chemically bound water (g/g of cement) in PLC-LF0 (11% LF) and PLC-LF29 (40% LF) samples. FIG. 8B shows the same TGA results of FIG. 8A showing chemically bound water (g/g of cement) in PLC-LF0 (11% LF) and PLC-LF29 (40% LF) samples, and additionally TGA results showing chemically bound water (g/g of cement) in PLC-LF14 (25% LF). FIG. 8C shows TGA results showing chemically bound water (g/g of binder) in PLC-LF0 (11% LF), PLC-LF14 (25% LF), and PLC-LF29 (40% LF) samples.

FIGS. 9A and 9B show TGA result showing weight loss as a function of temperature from 25 to 900° C. FIG. 9A shows TGA results of PLC, PLC-LF14 and PLC-LF29 without CNF. FIG. 9B shows TGA results of PLC-LF29 mixture with CNF addition of 0%, 0.15 wt. % and 0.3 wt. %.

FIG. 10 shows normalized compressive strength vs. cement volume fraction for mixtures containing different CNF dosages and levels of LF replacement. The variation in cement volume fraction is due to the partial replacement of LF with cement.

FIGS. 11A-11C show analysis of environmental and economic impacts of a mixture of the present disclosure (PLC-LF29-CNF0.3 mixture). FIG. 11A shows a comparison of CNF dosage and cost with other additive materials used in 3D-printed concrete. FIG. 11B shows a comparison of the carbon footprint and material cost of a mixture of the present disclosure with comparative 3D-printed concrete mixtures. Comparison of the material cost of the mixture developed in this study with commercial 3DP concrete materials. FIG. 11C shows a cost comparison based on current market prices for commercially available 3DP concrete materials.

### DETAILED DESCRIPTION

It is an object of the present disclosure to develop a low-carbon, cost-effective, sustainable printable concrete that incorporates cellulose nanofiber (CNF) and limestone filler (LF) to achieve a synergy between rheological performance, mechanical properties, and sustainability. LF is considered as a substitute for cement to reduce the clinker content in blended cement, which is a critical step toward decarbonizing the cement and concrete industry. CNF, a renewable and sustainable material, has garnered significant interest across various scientific and technical fields.

The construction system of the present disclosure includes a cementitious composition that may be utilized with additive manufacturing techniques, such as 3D printing. In certain circumstances, the construction system may include a cement mixture and cellulose nanofibers (CNF). In a specific example, the construction system may include limestone. It is contemplated that where the cement mixture already provides limestone, a supplementary portion of limestone may be added. In a more specific example, the construction system may include up to around forty percent by weight limestone.

It was surprisingly discovered that the use of cellulose nanofibers as a viscosity modifying admixture may raise static yield in conjunction with increased amounts of limestone powder to affect cure kinetics. The combination may reduce costs and carbon footprint. In certain circumstances, the construction system may improve build height by adjusting static yield of the cement mixture. At the same time, the mix may become lower in carbon footprint, lower cost, and may have improved hardened properties. For instance, the use of higher amounts of limestone powder may allow for lower carbon footprint and lower the cost to manufacture. At the same time, the CNF may improve the static yield at 1/20 the dosing of known commercial viscosity modifying admixture (VMA).

Further areas of applicability will become apparent from the description provided herein. The description and specific examples in this summary are intended for purposes of illustration only and are not intended to limit the scope of the present disclosure.

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### Definitions

Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the terms “including,” “containing,” and “comprising” are used in their open, non-limiting sense.

As used herein, the terms “accelerator” and “cement accelerator” refer to chemical admixtures that speed up the hydration process of cement. Accelerators may lead to faster setting times and increased early strength development in concrete. Examples of accelerators include, but are not limited to, calcium chloride, calcium nitrate, calcium formate, aluminum sulfate, and triethanolamine.

As used herein, the term “curing” refers to the action taken to maintain moisture and temperature conditions in a placed cementitious mixture to allow cement hydration and, if applicable, pozzolanic reactions to occur so that the potential properties of the mixture may develop. For example, curing can refer to a chemical reaction (e.g., a pozzolanic reaction) between water and a cementitious material, such as cement, to provide a water-cured composition that can be referred to as a “hydraulic” composition. A “cured” composition refers to a cementitious mixture that has begun or undergone curing, and has begun or undergone setting and hardening.

The term “about” as used herein means greater or lesser than the value or range of values stated by 10 percent, but is not intended to designate any value or range of values to only this broader definition. Each value or range of values preceded by the term “about” is also intended to encompass the embodiment of the stated absolute value or range of values. To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

As used herein, the notation “XXLF” refers to a composition with a particular limestone content of the binder. For example, “11LF” may refer to a composition having a 11% limestone by weight of the binder, “25LF” may refer to a composition having a 25% limestone by weight of the binder, and “40LF” may refer to a composition having a 40% limestone by weight of the binder.

As used herein, the notation “PLC-LFXX” refers to a composition with a particular limestone content of the binder. For example, “PLC-LF0” may refer to a composition having a 11% limestone (11% from PLC and 0% from supplemental limestone) by weight of the binder, “PLC-LF14” may refer to a composition having a 25% limestone (11% from PLC and 14% from supplemental limestone) by weight of the binder, and “PLC-LF29” may refer to a composition having a 40% limestone (11% from PLC and 29% from supplemental limestone) by weight of the binder.

As used herein, the notation “CNFXX” refers to a composition with a particular CNF content relative to the binder. For example, PLC-LF29-“CNF0.3” may refer to a composition having 0.3% CNF by weight relative to the binder.

As used herein, a weight percentage “relative to the binder” means a weight percentage of a component that is calculated from the total weight of the binder and is included in the composition in addition to the total weight of the binder. In a representative example where the composition comprises 1% CNFs by weight relative to the binder, if the composition has a total binder weight of 100 kg, then the composition comprises 1 kg CNFs. A weight percentage of a component “relative to the binder” may also be represented by a ratio (wt/wt) of the component to the binder. For example, a composition comprising 1% CNFs by weight relative to the binder may also be represented by a ratio (wt/wt) of CNFs to the binder of 1:100.

### Representative Embodiments

In some embodiments, the disclosure provides a composition comprising: a binder comprising a cementitious material and limestone, and a plurality of cellulose nanofibers (CNFs). In some embodiments, the binder comprises a cementitious material and a filler, such as a limestone filler (i.e., limestone).

In some embodiments, the composition comprises about 0.01% to about 1% CNFs by weight relative to the binder. For example, the composition may comprise about 0.1% to about 0.6% CNFs by weight, about 0.1% to about 0.5% CNFs by weight, or about 0.1% to about 0.4% CNFs by weight relative to the binder. In some embodiments, the composition comprises about 0.3% CNFs by weight relative to the binder.

In some embodiments, the composition comprises a ratio (wt./wt.) of CNFs to the binder of about 0.01:100 to about 1:100. For example, the composition may comprise a ratio (wt./wt.) of CNFs to the binder of about 0.1:100 to about 0.6:100, about 0.1:100 to about 0.5:100, or about 0.1:100 to about 0.4:100. In some embodiments, the composition comprises a ratio (wt./wt.) of CNFs to the binder of about 0.3:100.

In some embodiments, the final CNF content in the composition is provided by diluting a CNF slurry. The CNF slurry may comprise about 1% to about 5% solids. The CNF slurry may comprise a particular solids content in water. For example, the CNF slurry may comprise about 1% to about 5% solids in water, such as about 3% solids in water.

In some embodiments, the fibers of the CNFs independently have a fiber width of about 1 nm to about 500 nm. For example, the fibers of the CNFs may independently have a fiber width of about 10 nm to about 100 nm, such as about 50 nm.

In some embodiments, the fibers of the CNFs have a fiber length of about 50 μm to about 5 mm. For example, the fibers of the CNFs may independently have a fiber length of about 100 μm to about 1000 μm.

In some embodiments, the binder comprises about 10% to about 70% limestone by weight. For example, the binder may comprise about 15% to about 50% limestone by weight or about 20% to about 60% limestone by weight, such as about 40% limestone by weight.

In some embodiments, the composition comprises a ratio of limestone by weight in the binder to CNF by weight relative to the binder. For example, a ratio of about 133:1 may represent a composition comprising 0.3% CNF by weight relative to the binder and a binder including 40% limestone by weight. In some embodiments, the composition comprises a ratio of limestone by weight in the binder to CNF by weight relative to the binder of about 50:1 to about 500:1, such as about 50:1 to about 400:1, such as about 133:1.

In some embodiments, the cementitious material comprises limestone. In some embodiments, the cementitious material comprises about 1% to about 25% limestone by weight. For example, the cementitious material may comprise about 5% to about 15% limestone by weight, such as about 11% limestone by weight.

In some embodiments, the limestone content in the binder is provided by supplemental limestone, or a combination of supplemental limestone and limestone of the cementitious material. In some embodiments, the binder comprises a cementitious material comprising limestone, and supplemental limestone. Supplemental limestone, for example, may be limestone that is not included in the cementitious material.

In some embodiments the binder comprises about 5% to about 60% supplemental limestone by weight. For example, the binder may comprise about 10% to about 50% supplemental limestone by weight, such as about 14% or about 29% supplemental limestone by weight.

In some embodiments, the limestone (e.g., supplemental limestone) has a median diameter of about 1 micron to about 5 micron, such as about 1.4 micron.

In some embodiments, the binder consists of a cementitious material and limestone.

In some embodiments, the composition comprises water. In some embodiments, the composition comprises a ratio (wt./wt.) of water to the binder of about 0.1 to about 1.0. For example, the composition may comprise a ratio (wt./wt.) of water to the binder of about 0.2 to about 0.6, such as about 0.4.

In some embodiments, the composition comprises an aggregate. The aggregate, for example, may be sand, gravel, or a combination thereof. In some embodiments, the composition comprises sand. The sand, for example, may be fine sand, coarse sand, or a combination thereof. In some embodiments, the sand (e.g., fine sand) has a maximum particle size of less than about 1 mm, such as about 0.2 mm to about 1 mm (e.g., about 0.6 mm). In some embodiments, the sand (e.g., coarse sand) has a maximum particle size of about 1 mm to about 4 mm, such as about 2.4 mm).

In some embodiments, the composition comprises a ratio (wt./wt.) of sand to the binder of about 0.5 to about 2. For example, the composition may comprise a ratio (wt./wt.) of sand by weight to the binder by weight of about 0.8 to about 1.2, such as about 1.

In some embodiments, the cementitious material is selected from the group consisting of cement, slag, fly ash, silica fume, and any combination thereof. In some embodiments, the cementitious material is cement. In some embodiments, the cementitious material is a combination of cement and an additive. In some embodiments, the cement is selected from the group consisting of Portland-limestone cement (PLC), ordinary portland cement (OPC), Calcium Sulfoaluminate cement (CSA), and any combination thereof. In some embodiments, the additive is selected from the group consisting of slag, fly ash, silica fume, nanoclay, nanosilica, cellulose ether, superplasticizer, and any combination thereof.

In some embodiments, the composition does not comprise silica fume, nanoclay, nanosilica, cellulose ether, superplasticizer, or any combination thereof. In some embodiments, the composition does not comprise an accelerator, such as calcium chloride, calcium nitrate, calcium formate, triethanolamine, aluminum sulfate, or any combination thereof. In some embodiments, the composition is substantially free of an accelerator, such as calcium chloride, calcium nitrate, calcium formate, triethanolamine, aluminum sulfate, or any combination thereof.

In some embodiments, the composition consists of: a binder comprising a cementitious material and limestone, and a plurality of cellulose nanofibers (CNFs). In some embodiments, the composition consists of: a binder comprising a cementitious material and limestone, a plurality of cellulose nanofibers (CNFs), and water. In some embodiments, the composition consists of: a binder comprising a cementitious material and limestone, a plurality of cellulose nanofibers (CNFs), sand, and water.

In some embodiments, the composition has a static yield stress of greater than about 500 Pa. For example, the composition may have a static yield stress of about 500 Pa to about 2500 Pa, such as about 1000 Pa to about 2500 Pa. The static yield stress may be measured according to Example 1.

In some embodiments, the composition has a storage modulus of greater than about 50 kPa. For example, the composition may have a storage modulus of about 50 kPa to about 120 kPa, such as about 75 kPa to about 100 kPa. The storage modulus may be measured according to Example 1.

In some embodiments, the composition has a critical strain of greater than about 0.05%. For example, the composition may have a critical strain of about 0.05% to about 0.5%, such as about 0.1% to about 0.5%. The critical strain may be measured according to Example 1.

In some embodiments, the composition has a viscosity of about 0.2 Pa·s to about 1.5 Pa·s. For example, the composition may have a viscosity of about 0.5 Pa·s to about 1 Pa·s or about 0.8 Pa·s to about 1.2 Pa·s. In some embodiments, the composition has a viscosity of less than about 1.5 Pa·s, less than about 1.2 Pa·s, or less than about 1.0 Pa·s. The viscosity may be measured according to Example 1.

In some embodiments, the composition has a static yield stress per viscosity of about 1000 Pa per Pa·s to about 4000 Pa per Pa·s. For example, the composition may have a static yield stress per viscosity of about 2000 Pa per Pa·s to about 3000 Pa per Pa·s.

In some embodiments, the composition has a compressive strength of greater than about 30 MPa. For example, the mortar may have a compressive strength of about 30 MPa to about 50 MPa. The compressive strength may be measured according to Example 1.

In some embodiments, the composition has a flexural strength of greater than about 5 MPa. For example, the mortar may have a flexural strength of about 5 MPa to about 10 MPa, such as about 7 MPa to about 10 MPa. The flexural strength may be measured according to Example 1.

In some embodiments, the disclosure provides a mortar. In some embodiments, the mortar comprises: a binder comprising a cementitious material and limestone, a plurality of cellulose nanofibers (CNFs), sand (e.g., fine sand or coarse sand), and water. In some embodiments, the mortar comprises the composition as described herein, sand, and water.

In some embodiments, the mortar comprises about 0.01% to about 1.00% CNFs by weight relative to the binder. For example, the mortar may comprise about 0.1% to about 0.6% CNFs by weight, about 0.1% to about 0.5% CNFs by weight, or about 0.1% to about 0.4% CNFs by weight of the binder. In some embodiments, the mortar comprises about 0.3% CNFs by weight relative to the binder.

In some embodiments, the mortar comprises a ratio (wt./wt.) of water to the binder of about 0.1 to about 1.0. For example, the mortar may comprise a ratio (wt./wt.) of water to the binder of about 0.2 to about 0.6, such as about 0.4.

In some embodiments, the mortar comprises an aggregate. The aggregate, for example, may be sand, gravel, or a combination thereof. In some embodiments, the mortar comprises sand. The sand, for example, may be fine sand, coarse sand, or a combination thereof. In some embodiments, the sand (e.g., fine sand) has a maximum particle size of less than about 1 mm, such as about 0.2 mm to about 1 mm (e.g., about 0.6 mm). In some embodiments, the sand (e.g., coarse sand) has a maximum particle size of about 1 mm to about 4 mm, such as about 2.4 mm).

In some embodiments, the mortar comprises a ratio (wt./wt.) of sand to the binder of about 0.5 to about 2. For example, the mortar may comprise a ratio (wt./wt.) of sand to the binder of about 0.8 to about 1.2, such as about 1.

In some embodiments, the mortar has a compressive strength of greater than about 30 MPa. For example, the mortar may have a compressive strength of about 30 MPa to about 50 MPa. The compressive strength may be measured according to Example 1.

In some embodiments, the mortar has a flexural strength of greater than about 5 MPa. For example, the mortar may have a flexural strength of about 5 MPa to about 10 MPa, such as about 7 MPa to about 10 MPa. The flexural strength may be measured according to Example 1.

In some embodiments, the mortar does not comprise silica fume, nanoclay, nanosilica, cellulose ether, superplasticizer, or any combination thereof. In some embodiments, the mortar does not comprise an accelerator, such as calcium chloride, calcium nitrate, calcium formate, triethanolamine, aluminum sulfate, or any combination thereof.

In some embodiments, the composition as described herein or the mortar as described herein is used in a printing operation, such as a 3D printing method, to provide a structure, such as a multilayer structure as described herein.

In some embodiments, the disclosure provides a multilayer structure. In some embodiments, the multilayer structure includes any suitable number of layers, such as 2 to 500 layers. the multilayer structure may include a particular number of layers. In some embodiments, the multilayer structure may comprise any suitable number of total layers, or it can be advantageous to limit the number of total layers according to structure manufacturing capabilities. In some embodiments, the multilayer structure includes at least about 2 layers, at least about 5 layers, at least about 10 layers, at least about 25 layers, at least about 50 layers, at least about 75 layers, or at least about 100 layers.

In some embodiments, multilayer structure comprises: a first layer and a second layer. In some embodiments, the second layer is arranged to be in contact with the first layer. In some embodiments, the second layer is arranged to be in direct contact (i.e., without an intervening layer or support) with the first layer. In some embodiments, the second layer has been applied to or deposited on the first layer, for example, in a printing operation. In some embodiments where the multilayer structure includes a first layer, a second layer applied to or deposited on the first layer, and any number of additional layers, each additional layer may be applied to or deposited on any applied or deposited layer (e.g., the first layer, the second layer, or additional layer, when present).

In some embodiments, the first layer comprises the composition as described herein, sand, and water, or the mortar as described herein, and water. In some embodiments, the first layer comprises: a binder comprising a cementitious material and limestone, a plurality of cellulose nanofibers (CNFs), optionally sand, and water.

In some embodiments, the second layer comprises the composition as described herein or the mortar as described herein, and water. In some embodiments, the second layer comprises: a binder comprising a cementitious material and limestone, a plurality of cellulose nanofibers (CNFs), optionally sand, and water.

In some embodiments, each of the first layer and the second layer independently comprises the composition as described herein or the mortar as described herein, and water. In some embodiments, each of the first layer and the second layer independently comprises: a binder comprising a cementitious material and limestone, a plurality of cellulose nanofibers (CNFs), optionally sand, and water.

In some embodiments, the multilayer structure does not comprise a support structure, such as a three-dimensional support, a rod, a wall, or a mold. A support structure may include a composition or mortar that has undergone (completed) a curing process prior to the composition or mortar of the multilayer structure.

In some embodiments, the multilayer structure comprises an overhang of at least about 5 degrees, such as about 5 degrees to about 60 degrees.

In some embodiments, the multilayer structure comprises a layer (e.g., the second layer) arranged to form an overhang of at least about 5 degrees, such as about 5 degrees to about 60 degrees, relative to another layer in contact with the layer (e.g., the first layer).

In some embodiments, the multilayer structure comprises a cuboid geometry or columnar geometry. In some embodiments, the multilayer structure comprises a hollow region. The hollow region, for example, may comprise a diameter of about 1 mm to about 1 m (1000 mm), such as about 1 mm to about 100 mm or about 0.1 m to about 1.0 m.

In some embodiments, a layer (e.g., the first layer, the second layer, or any suitable layer) of the multilayer structure comprises a thickness of about 1 mm to about 50 mm. For example, a layer of the multilayer structure may comprise a thickness of about 2 mm to about 25 mm, such as about 2 mm, about 4 mm, about 10 mm, or about 25 mm.

In some embodiments, the multilayer structure comprises a thickness (i.e., the total height of stacked layers) about 1 mm to about 1 m (1000 mm), such as about 1 mm to about 100 mm or about 0.1 m to about 1.0 m.

In some embodiments, the disclosure provides a method of making a structure, such as a multilayer structure as described herein. In some embodiments, the method comprises the steps of: extruding a mortar through an extruder to provide an extrudate; and depositing the extrudate onto a surface to provide the structure. The mortar, for example, may comprise a binder comprising a cementitious material and limestone, a plurality of cellulose nanofibers (CNFs), sand, and water.

In some embodiments, the method comprises a step of mixing a binder comprising a cementitious material and limestone, a plurality of cellulose nanofibers (CNFs), sand, and water to provide the mortar.

In some embodiments, the surface is a flat, planar surface. In some embodiments, the surface is a printing bed. In some embodiments, the surface does not comprise a support structure, such as a three-dimensional support, a rod, a wall, or a mold. A support structure may also include a composition or mortar that has undergone (completed) a curing process prior to the extrudate. A composition or mortar that has undergone a curing process may refer to a composition or mortar.

In some embodiments, the method comprises a step of transferring the mortar through a pump to the extruder, wherein the extruder is coupled (e.g., fluidly coupled) to the pump.

In some embodiments, the method comprises a step of one of (i) moving the extruder, (ii) moving the surface, or (iii) independently moving both the extruder and the surface in a direction (e.g., a one-dimensional direction, a two-dimensional direction, or a three-dimensional direction) to provide the structure. In some embodiments, (i), (ii), or (iii) independently move in a direction (e.g., a one-dimensional direction, a two-dimensional direction, or a three-dimensional direction) to provide the structure.

In some embodiments, the step of moving the extruder comprises moving the extruder in a direction parallel (along a horizontal x-y axis) to the surface. In some embodiments, the step of moving the extruder comprises moving the extruder in a direction parallel (along a horizontal x-y axis) to the surface and a direction orthogonal (along a vertical z axis) to the surface.

In some embodiments, the step of moving the surface comprises moving the surface in a direction parallel (along a horizontal x-y axis) to the surface. In some embodiments, the step of moving the surface comprises moving the surface in a direction orthogonal (along a vertical z axis) to the surface.

In some embodiments, multiple x-y planar layers can be formed on (applied to or deposited on) each other in the vertical z direction to form the structure. In some embodiments, the extruder can form an angle (i.e., a tilted angle) with the vertical z direction, e.g., forming an angle with the normal direction of the surface. In some embodiments, the extruder forms an offset angle with the surface. The offset angle can allow the extruder to deposit a layer of extrudate with overhang.

In some embodiments, the extruder is configured to be movable with respect to the tilted angle, such as rotating to change the tilted angle. The movement can be performed manually, or can be controlled by a controller coupled to the extruder. The controller may be coupled to a robotic arm that is coupled (or connected) to the extruder. The adjustable tilted extruder can allow printing overhang features having different overhang angles. The extruder angle can be continuously adjustable, e.g., rotatable through a motor, or can be incrementally adjustable, e.g., rotatable through a pneumatic or hydraulic cylinder.

In some embodiments, the step of extruding is performed at a speed of about 10 mm/min to about 1000 mm/min.

In some embodiments, the extruder comprises a die (e.g., a nozzle) having a diameter of about 1 mm to about 100 mm, such as about 1 mm to about 50 mm.

In some embodiments, the method excludes a step of adding an accelerator to the composition, mortar, or extrudate.

In some embodiments, the step of depositing comprises depositing the extrudate (e.g., a layer of extrudate) onto the surface to provide a first layer of the structure, and depositing the extrudate (e.g., another layer of extrudate) onto the first layer of the structure to provide a second layer of the structure in contact (e.g., direct contact) with the first layer. The step of depositing, for example, may comprise depositing multiple layers of extrudate onto the surface to provide a multilayer structure. In some embodiments where the multilayer structure includes a first layer, a second layer deposited on the first layer, and optionally any number of additional layers, the step of depositing comprises depositing the extrudate (e.g., a layer of extrudate) onto any deposited layer (e.g., the first layer, the second layer, or additional layer, when present).

In some embodiments, the method comprises depositing at least about 2 layers, at least about 5 layers, at least about 10 layers, at least about 25 layers, at least about 50 layers, at least about 75 layers, or at least about 100 layers onto the surface.

In some embodiments, a layer (e.g., the second layer) of the extrudate is deposited onto another layer of extrudate, thereby forming an overhang of at least about 5 degrees, such as about 5 degrees to about 60 degrees.

In some embodiments, the method comprises a step of curing the structure. The step of curing may be performed, for example, at ambient temperature. In some embodiments, the step of curing is performed for at least about 0.5 hours, such as at least about 1 hour, at least about 2 hours, at least about 10 hours.

### EXAMPLES

The examples and preparations provided below further illustrate and exemplify particular aspects of embodiments of the disclosure. It is to be understood that the scope of the present disclosure is not limited in any way by the scope of the following examples. All ASTM, ISO, and other standard test methods cited or referred to in this disclosure are incorporated by reference in their entirety.

### Example 1

### Materials and Methods

Materials and mixtures: All mixtures were prepared with a water-to-binder ratio of 0.4 (by weight). For the mortar used in 3D printing and mechanical evaluation, a sand-to-binder ratio of 1 (by weight) was used. Type IL cement (PLC) from Buzzi Unicem USA, comprising 11% limestone filler (LF) and 89% cement, served as the base material. Omya F fine limestone filler, with a median particle diameter of 3 microns, was used to partially replace the Type IL cement. Two levels of LF replacement were studied: (1) PLC with an additional 14% LF replacing cement, denoted as PLC-LF14, resulting in a total of 25% LF replacement compared to OPC without LF; (2) PLC with an additional 29% LF replacing cement, denoted as PLC-LF29, resulting in a total of 40% LF replacement compared to OPC without LF. CNF was obtained from the University of Maine Process Development Center (lot U22) in the form of a slurry with a 3% solid content in water. The CNF had a nominal fiber width of 50 nm and lengths of several hundred microns. CNF was incorporated into the mixture as an addition, with its dry weight calculated as a percentage of the weight of the binder. For the rheology tests and cement hydration kinetic tests (isothermal calorimetry), paste material (without sand) was used. For the small-scale printing and mechanical tests, river sand with a maximum particle size of 0.6 mm was used as the fine aggregate for mortar. For large-scale printing, river sand with a maximum particle size of 2.36 mm was used as the fine aggregate. Detailed mix proportions are included in Table 1.

TABLE 1
Summary of paste mixture proportions used in this study.

| | | PLC | LF | Water | # CNF | Sand |
|---|---|---|---|---|---|---|
| Mixture | | (kg/m³) | (kg/m³) | (kg/m³) | (kg/m³) | (kg/m³) |
| Paste* | PLC-LF0-CNF0 | 1387.90 | 0 | 555.16 | 0 | / |
| | PLC-LF0-CNF0.15 | 1387.90 | 0 | 555.16 | 2.08 | / |
| | PLC-LF0-CNF0.3 | 1387.90 | 0 | 555.16 | 4.16 | / |
| | PLC-LF0-CNF0.5 | 1387.90 | 0 | 555.16 | 6.94 | / |
| | PLC-LF14-CNF0 | 1157.45 | 213.75 | 548.48 | 0 | / |
| | PLC-LF14-CNF0.15 | 1157.45 | 213.75 | 548.48 | 2.06 | / |
| | PLC-LF14-CNF0.30 | 1157.45 | 213.75 | 548.48 | 4.11 | / |
| | PLC-LF14-CNF0.50 | 1157.45 | 213.75 | 548.48 | 6.86 | / |
| | PLC-LF29-CNF0 | 918.81 | 441.78 | 544.24 | 0 | / |
| | PLC-LF29-CNF0.15 | 918.81 | 441.78 | 544.24 | 1.34 | / |
| | PLC-LF29-CNF0.30 | 918.81 | 441.78 | 544.24 | 2.67 | / |
| | PLC-LF29-CNF0.50 | 918.81 | 441.78 | 544.24 | 6.80 | / |
| | PLC-LF100-CNF0.3 | 0 | 1297.52 | 519.01 | 3.89 | / |
| Fine | PLC-LF0-CNFO | 904.20 | 0 | 361.68 | 0 | 904.20 |
| mortar** | PLC-LF0-CNF0.15 | 904.20 | 0 | 361.68 | 1.35 | 904.20 |
| | PLC-LF0-CNF0.3 | 904.20 | 0 | 361.68 | 2.71 | 904.20 |
| | PLC-LF14-CNF0 | 757.12 | 139.82 | 358.78 | 0 | 896.94 |
| | PLC-LF14-CNF0.15 | 757.12 | 139.82 | 358.78 | 1.35 | 896.94 |
| | PLC-LF14-CNF0.30 | 757.12 | 139.82 | 358.78 | 2.69 | 896.94 |
| | PLC-LF29-CNF0 | 601.02 | 288.98 | 358.78 | 0 | 890.00 |
| | PLC-LF29-CNF0.15 | 601.02 | 288.98 | 356.00 | 1.34 | 890.00 |
| | PLC-LF29-CNF0.30 | 601.02 | 288.98 | 356.00 | 2.67 | 890.00 |
| Coarse | PLC-LF29-CNF0.30 | 601.02 | 288.98 | 356.00 | 2.67 | 890.00 |
| mortar*** | | | | | | |

*All pates mixed at water-binder ratio of 0.40
**The maximum diameter of sand particles used in the fine mortars was 0.6 mm. These fine mortars were used in small-scale printing.
***The maximum diameter of sand particles used in coarse mortars was 2.36 mm. These coarse mortars were used for large-scale printing.
# Weight of CNF was calculated with respect to the dry weight of the binder (PLC + LF). The number shown in the table represents the dry weight of CNF.

Mixing procedure: High shear mixing was used to effectively disperse the CNF. The mixing water was first added to the CNF slurry, which was then subjected to high-speed shear mixing using a regular blender for two minutes to ensure proper dispersion of the CNF. For rheology tests, paste materials were prepared with consistent shear history. The dry LF and cement were mixed until a homogeneous blend was achieved. The pre-mixed CNF solution (containing mixing water and CNF after high shear mixing) was measured and added to the dry materials, which were then mixed for two minutes using a hand mixer at a consistent speed. The paste was subsequently loaded into a cup and hand-tamped to remove air bubbles before transferring to the rheometer. A similar mixing procedure was used for isothermal calorimetry tests. For the mortar used in small scale 3D printing and mechanical testing, all dry solid materials were measured and mixed in a Hobart 5-Qt bowl mixer at low speed for 2 minutes. The pre-mixed CNF solution was then added to the solids and mixed at medium speed for an additional two minutes. For large scale 3D printing, a large 3½ cubic Ft. mixer was used. The dry solid materials were first mixed in the mixer until a homogeneous blend was achieved, after which the pre-mixed CNF solution was added and mixed until a uniform consistency mortar was reached.

Rheology test: A rheological protocol was developed to measure critical rheological properties relevant to 3DP concrete: static yield stresses, viscosity, storage modulus, and critical strain. At least three measurements were collected for each mix using fresh mixtures prepared following the same mixing procedure and controlling the time between water addition and rheological characterization.

The rheological tests were conducted with an Anton Paar MCR 702 rheometer using a four-blade vane and cup geometry. Critical rheological properties relevant to 3D printing measured during the test included: static yield stresses, viscosity, storage modulus, and critical strain. At least three measurements were collected for each mix using fresh mixtures prepared following the same mixing procedure and controlling the time between water addition and rheological characterization.

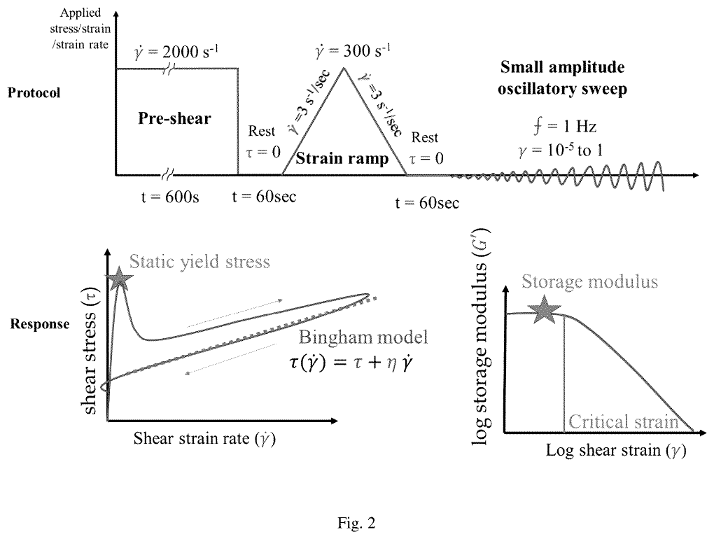

The rheological protocol, illustrated in FIG. 2, began with a pre-shear of the mixture at shear rate of 2000 s⁻¹ to ensure all mixtures reached a steady-state response representing a deflocculated state. Following the pre-shear, a 60-second rest period under zero stress was applied. Subsequently, a hysteresis loop (strain ramp) was implemented, with the shear rate progressively increasing from 0 s⁻¹ to 300 s⁻¹ at a rate of 3 s⁻¹/s, and then decreasing from 300 s⁻¹ to 0 s⁻¹ at same rate of 3 s⁻¹/s. The maximum shear stress recorded during the initial stage of the test was designated as the static yield stress of the mix as illustrated in FIG. 2. The Bingham model fits a linear regression model on the linear region of the ramp down curve were used to determine the dynamic yield stress and viscosity. After another 60-second zero-stress rest period, a small amplitude oscillatory shear was applied at a frequency of 1 Hz, with a logarithmic strain sweep from 1×10⁻⁵ to 1. The storage modulus (G′) was continuously recorded, displaying an initial linear viscoelastic regime (LVR) where G′ remained nearly constant, followed by a drop indicating the end of the LVR and irreversible damage to the rigid structure. The strain amplitude at the end of the LVR was identified as the critical strain.

Mechanical test: Compressive tests were conducted on 50 mm×50 mm×50 mm cube specimens after 28 days of air curing. The material preparation followed the mixing procedure described in the previous section. To ensure accurate testing, the surfaces in contact with the mold were used, providing a flat surface for proper contact with the loading and support fixtures. Compressive strength was assessed using an MTS machine with a 300 kN capacity, at a displacement rate of 0.5 mm/min. Flexural tests were performed on 3D printed beam specimens with dimensions of 30 mm×36 mm×170 mm, utilizing a 3-point bending configuration. The span length for the 3-point bending tests was 150 mm. These flexural tests were conducted after 7 days of air curing. The top and bottom surfaces of the 3DP beams were smooth, ensuring adequate contact with the loading and support fixtures. Consequently, the specimens were tested in their “as-printed” orientation. The flexural tests were carried out using an MTS machine with a 10 kN capacity and a displacement rate of 0.2 mm/min. At least three measurements were collected for each test group.

Isothermal calorimetry: Isothermal calorimetry was used to evaluate the influence of CNF and LF on the hydration kinetics of cement, which also provides insight into the results observed in the rheology tests. Hydration kinetics were investigated for the hydrating mixes at 23° C. using isothermal calorimetry (TAM Air). Following the mixing procedures described above, approximately 10 g of paste was loaded into each standardized glass ampule. The hydration of PLC and two LF replacement levels (PLC-LF14 and PLC-LF29) with three CNF addition levels (0.15%, 0.3%, and 0.5%) was studied. The heat flow data was recorded for 5 days.

Thermogravimetric analysis: Thermogravimetric analysis was performed to assess the influence of CNF and LF on cement hydration under air cured conditions. A Thermogravimetric Analyzer (Q50, TA Instruments) was used to heat the samples to a maximum temperature of 900° C. at a heating rate of 10° C./min to assess weight loss and quantify chemically bound water. Samples for TGA analysis were taken from broken pieces of specimens tested for compressive strength after 28 days of dry curing. To arrest hydration, the samples underwent solvent exchange with isopropanol. Mortar pieces were immersed in 120 ml of isopropanol for 5 days, and the isopropanol was replaced after the first 3 days. The mortar pieces were then dried and stored in a vacuum desiccator for an additional 4 days to evaporate the isopropanol. The dried samples were ground into powder and sieved through a #200 mesh before TGA testing.

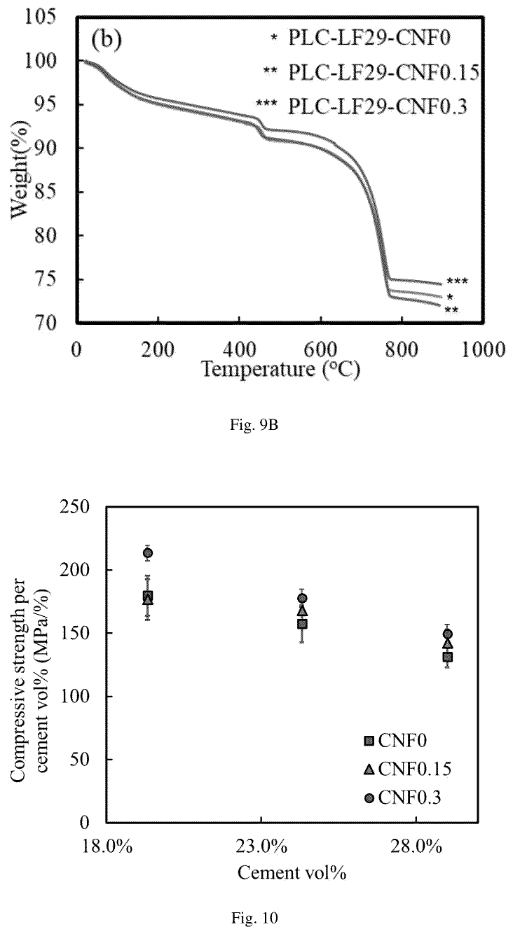

The total mass of chemically bound water in the sample was determined using TGA analysis. FIG. 9A and FIG. 9B present example TGA results for 28-day samples with varying levels of LF replacement and CNF addition. The mass loss observed between 400° C. and 500° C. corresponds to the decomposition of Ca(OH)₂, while the weight loss above 600° C. is attributed to CO₂ release due to the decomposition of CaCO₃. The addition of LF in the PLC-LF14 and PLC-LF29 mixture resulted in greater weight loss above 600° C. The chemically bound water was quantified as the weight loss occurring between 100° C. and 600° C. during the TGA test.

Multi-scale 3D printing systems: Both small-scale and large-scale 3D printers were used to test the mixture formulation. For small-scale printing, an extrusion-based 3D printer (Hyrel 16A) was utilized), with a plastic syringe of 150 cm³ capacity serving as the printing head. The head was mounted on a frame enabling X-Y movement, while Z-axis movement was achieved by moving the printing bed. Printer operations, such as movement speed and flow rate, were controlled through a proprietary software (Repetrel 5.1). The design process began with creating a 3D model, followed by the use of slicer software (Simplify 3D) to define the printing parameters, paths, and generate the G-code (3D model, visualized toolpath, and 3DP sample of the complex overhang structure used in this study). The mortar was mixed according to the procedures described herein and then fed into the plastic syringe. For the buildability test of the complex geometry with overhang, a circular nozzle with a 4 mm opening was employed for printing the hollow column, with a layer height set at 2 mm. For the 3DP beam elements used in the flexural test, a circular nozzle with a diameter of 5.5 mm was employed. The beam elements were designed with a layer thickness of 4 mm. All small-scale printing was conducted at a speed of 750 mm/min.

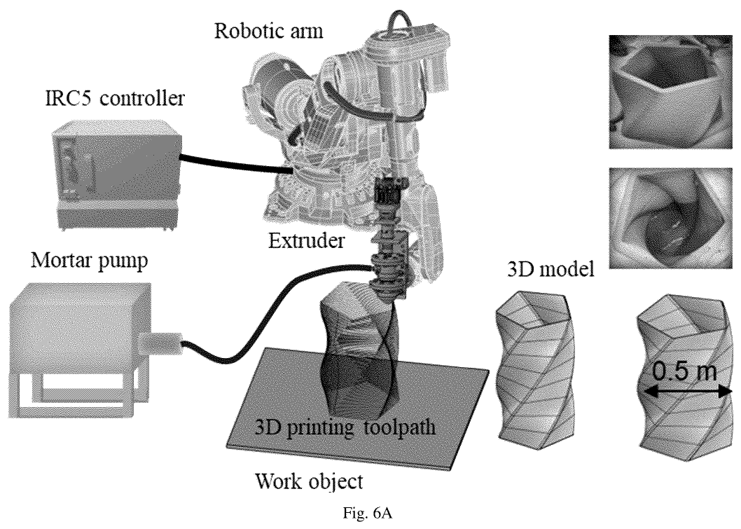

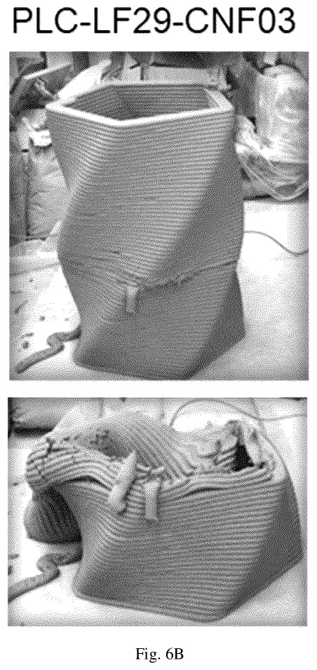

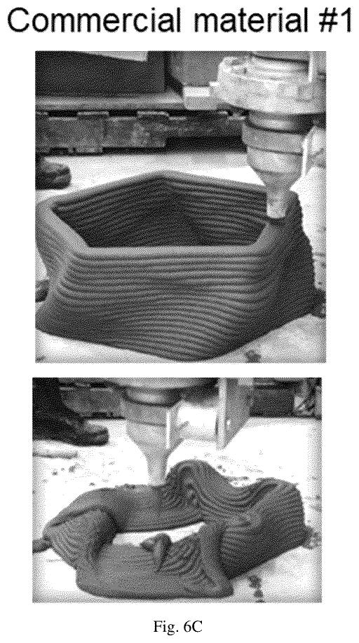

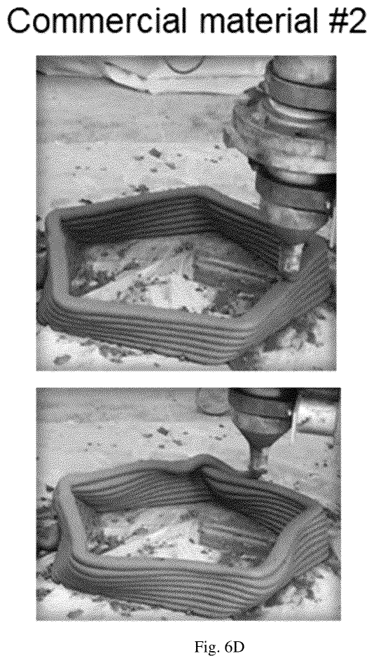

As shown in FIG. 6A, a robotic arm system was used for large-scale 3D printing performed in this study. This system consists of an ABB IRB 6700 robot arm, an ABB IRC5 controller, an M-Tech Duo Mix P20 pump, and an extruder designed by the research group, featuring shear mixing capabilities with a 25 mm circular nozzle opening. The shear mixing capability in the extruder facilitates better control of thixotropic behavior, enhancing the workability of the concrete during extrusion while allowing it to regain strength after deposition. Additionally, effective shear mixing helps prevent clogging of the extruder, ultimately improving precision and optimizing print quality. In this example, the 3D printing process began by generating a 3D model of a hollow column with overhang using Grasshopper software. Next, the column model was sliced using a Grasshopper-designed slicer to generate the RAPID code, which incorporated the desired printing parameters, including layer height, filament width, and printing speed. The RAPID code is used by ABB's IRC5 controller to control the robotic arm. Concrete was continuously mixed and fed into a cavity pump (M-tech Duo Mix P20), which delivered the material to the extruder through a hose with a 25 mm inner diameter for final deposition onto the work object. In this example, the layer thickness was designed as 10 mm and the robotic arm operated at a movement speed of 50 mm/s.

### Example 2

### Rheology and Cement Hydration Kinetics

3DP concrete requires specific rheological properties to ensure successful printing. Recent research has highlighted several critical rheological factors for 3DP concrete, including static, dynamic yield stress, critical strain, viscosity, storage modulus and thixotropy. These properties are influenced by colloidal forces, such as electrostatic interactions from adsorbed ions, along with rigid chemical forces from hydration processes that lead to the formation of hydration products like calcium silicate hydrate (C—S—H) links. A comprehensive rheology protocol was developed that incorporates high shear rate pre-shear, hysteresis loop test, and small amplitude oscillatory sweeps to measure these essential rheological properties (FIG. 2).

To explain the influence of LF and CNF on cement rheology, soft colloidal and rigid interaction mechanisms were used. The soft colloidal interaction represents the electrostatic forces due to adsorbed ions, Van der Waals forces and electrostatic repulsion. Previous studies on CNF have demonstrated that the hydroxyl and carboxyl surface groups on CNF can effectively bind to the calcium ions present on cement particles, inducing CNF-cement colloidal interactions. On the other hand, LF is assumed to lack such interaction with CNF due to its inert nature. Rheological testing of a mixture containing only LF, CNF, and water supports this assumption, as the results reveal low shear stress, indicating minimal colloidal interactions between LF and CNF. In addition to the CNF-cement interactions, soft colloidal interactions also exist between CNF themselves, as well as between cement particles. The rigid interactions include nucleation, which is surface-based C—S—H precipitation, and rigidification, which is C—S—H growth. To simplify the discussions, this study refers to all the rigid interaction and formation of the early hydration product as early age C—S—H formation. In this example, the influence of CNF and LF on the hydration kinetics of cement was first investigated, and subsequently, these findings were correlated with the rheological behavior of the CNF-LF-cement system.

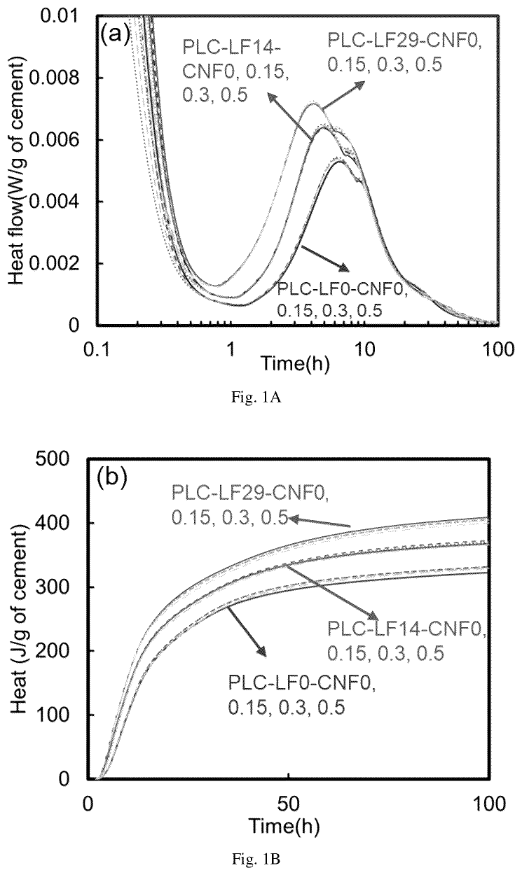

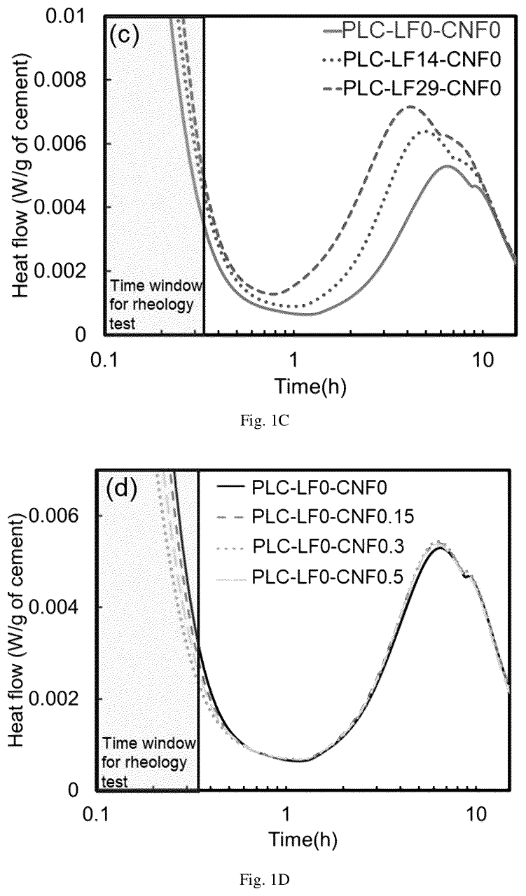

FIG. 1A presents the heat flow curves normalized by the weight of cement for all mixtures. The heat flow curves indicate that, overall, CNF has a negligible influence on the primary hydration kinetics of cement, regardless of the level of LF replacement. In contrast, the replacement of PLC with LF significantly influences hydration kinetics. The primary peak in the curves shifts to the left due to LF replacement, indicating that LF accelerates cement hydration, with more pronounced acceleration effect at higher LF replacement levels. This acceleration effect was unaffected by different CNF additions in the system. FIG. 1B illustrates the cumulative heat release normalized by the weight of cement. The results indicate that CNF has a negligible effect on total hydration heat. In contrast, total heat release increases with higher LF replacement levels. Furthermore, LF can influence the length of the induction hydration period. FIG. 1C shows the first 15 hours of heat flow curves for different LF levels without CNF. The acceleration effect remains evident during the induction period due to LF replacement, with the PLC-LF29 system exhibiting the highest heat flow and the shortest induction period. FIG. 1D presents the heat flow curves for varying CNF addition level in the PLC system. The results indicate that the addition of CNF has negligible effects on the induction period.

There are several mechanisms through which cellulose nano materials could influence cement hydration. First, the high surface area of CNF could provide nucleation sites for hydration products that enhance cement hydration. Additionally, the “short-circuit diffusion” effect has been proposed for cellulose nanocrystals (CNC), where CNC forms channels within the C—S—H layer, facilitating moisture transport from the pore solution to the core of unreacted cement particles, thereby enhancing hydration. In contrast, the hydroxyl and carboxyl groups in CNF can bind with calcium ions in cement, limiting the number of the nucleation sites and thereby retarding hydration. In this study, however, the lack of a significant effect of CNF during the induction period suggests that CNF is unlikely to inhibit nucleation. The influence of LF on cement hydration is primarily attributed to its filler effect. LF particles accelerate the hydration process by providing additional surface area for the nucleation of hydration products and by improving particle packing, which reduces the average distance between cement grains and alters the local cement-water environment, collectively accelerating the hydration process. This acceleration shortens the induction and acceleration stage of hydration, leading to a reduced setting time. To further probe the effects of CNF and LF during the induction stage, rheological characterization was performed within that period, as shown in FIG. 1C and FIG. 1D.

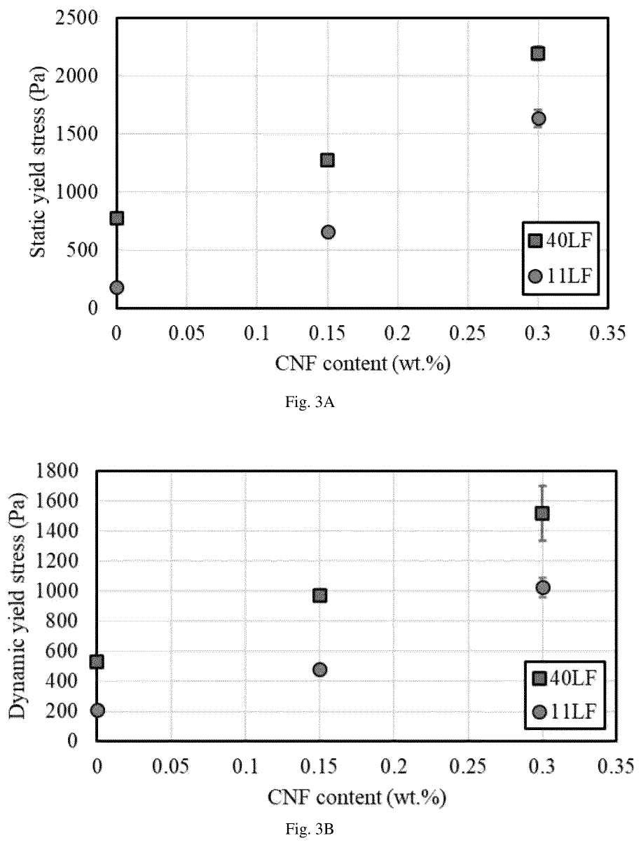

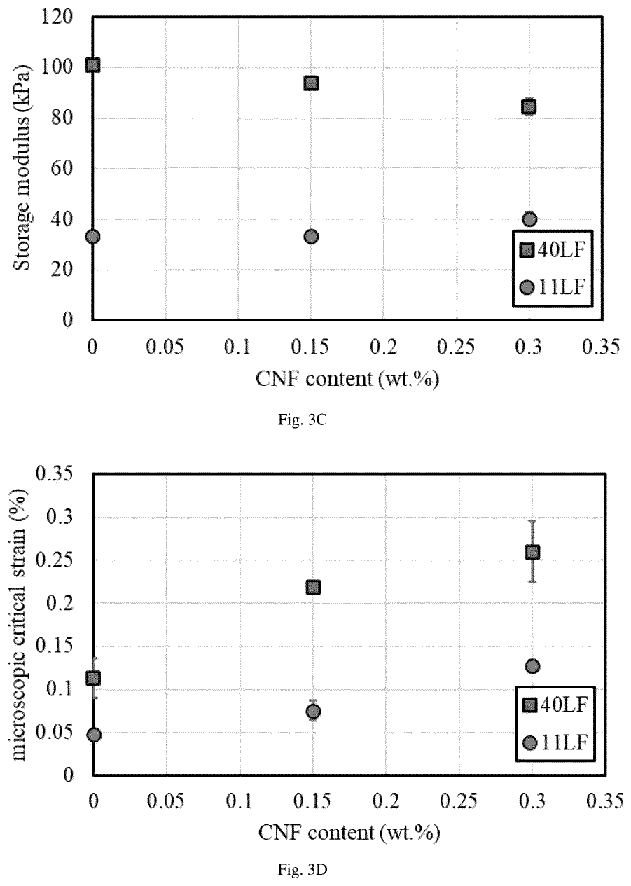

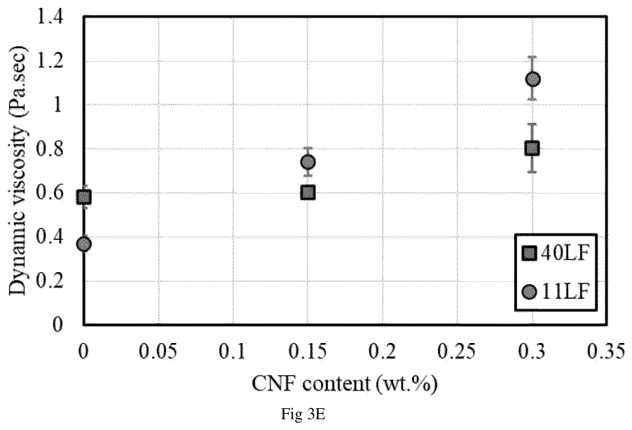

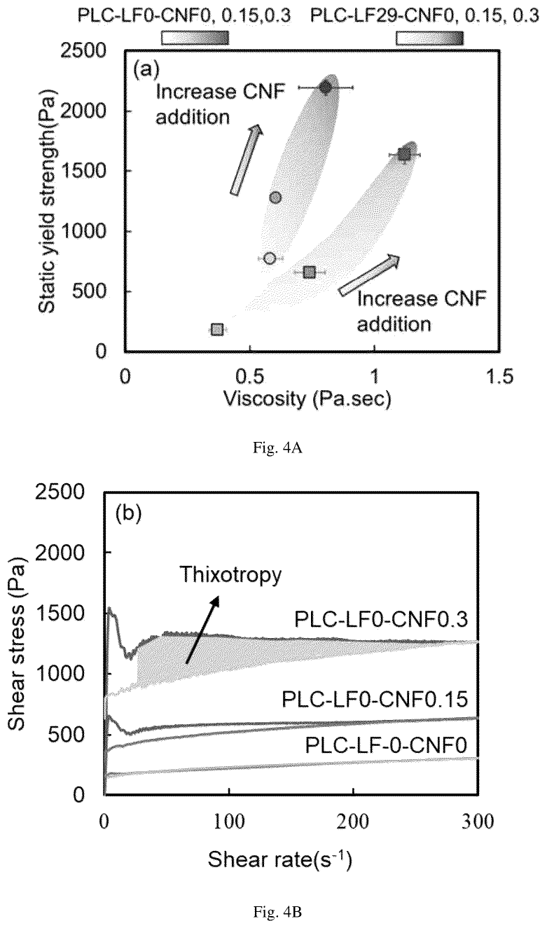

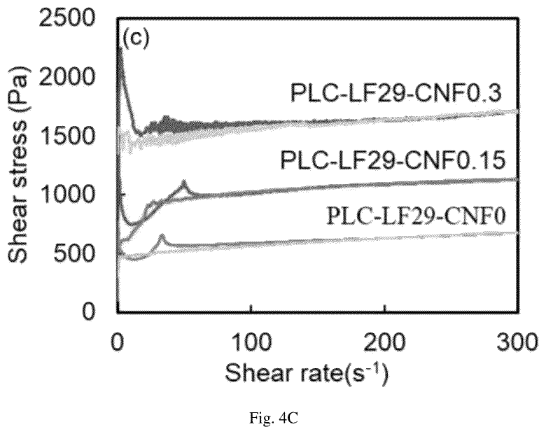

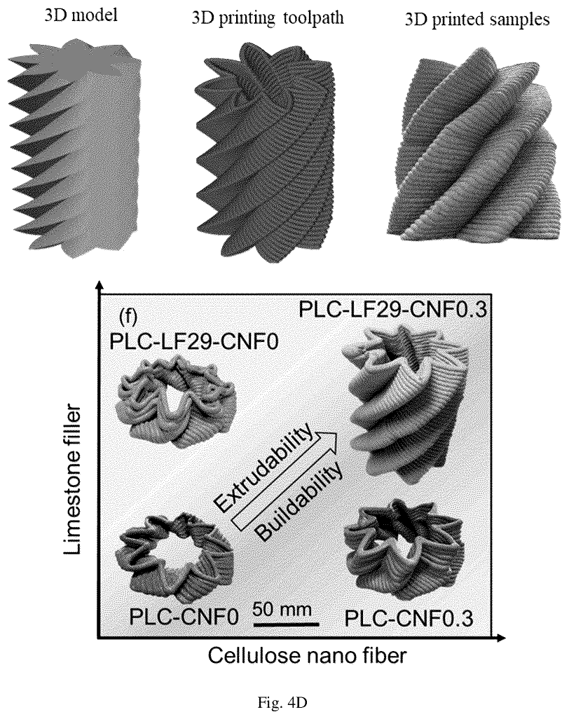

FIGS. 3A-3E and 4A-4D present the rheological test results for the cement-LC-CNF system following the rheology protocol presented herein. The maximum shear stress recorded in the initial phase of the hysteresis loop test was identified as the static yield stress. The Bingham model was applied to the linear region of the ramp-down curve to determine the dynamic yield stress and viscosity. FIG. 4A presents the static yield stress and viscosity across different CNF additions and LF replacement levels. Generally, CNF exhibits exceptional effectiveness in enhancing the static yield stress of cement paste. For the PLC system, the static yield stress is enhanced by 903% with only 0.3 wt. % CNF addition. Additionally, when combining LF and CNF, the PLC-LF29-CNF0.3 system exhibits a 1213% increase in static yield stress compared to the reference case of PLC-CNF0. Surprisingly, the enhancement in static yield stress occurs despite CNF's negligible influence on hydration during the induction period (FIG. 1D). This suggests that the increase in yield stress due to CNF arises primarily from physical and colloidal structuring mechanisms, rather than from chemical stiffening associated with hydration product formation. As discussed earlier, CNF has a high specific surface area and is rich in hydroxyl and carboxyl surface groups, which promote electrostatic interactions with cement particles, facilitating the formation of a colloidal network that resists flow. Additionally, CNF fibers can form an entangled physical network, further reinforcing the structure and contributing to the observed increase in static yield stress. The increase in static yield stress with LF replacement alone can be attributed to chemical stiffening of the rigid network, driven by enhanced formation of hydration products, as indicated by the observed increases in heat of hydration.

The viscosity of the mixes also increases with CNF addition, but this effect is moderated by replacing LF in the system. Specifically, adding 0.3 wt. % CNF to the PLC system results in a 302.8% increase in viscosity. In contrast, the PLC-LF29-CNF0.3 system exhibits only a 138.2% increase in viscosity compared to the reference mix without CNF and LF, while still substantially enhancing static yield stress. This synergy between CNF and LF is crucial for 3DP concrete, which requires relative low viscosity for pumpability and extrudability, while also needing high static yield stress to support the layers built on top. Typically, additives that enhance yield stress also substantially increase viscosity, which can compromise pumpability. However, the CNF-LF-cement system exhibited distinct performance, improving static yield stress while limiting the impact on viscosity.

The results of thixotropy, storage modulus, and critical strain provide further insight into the underlying interactions within the system. FIGS. 4B and 4C illustrate the shear rate vs. shear stress curves from the hysteresis loop test. During the first stage of hysteresis loop test, as the material is subjected to an increasing shear rate, its internal structure progressively breaks down. Conversely, when the shear rate decreases, the material begins to rebuild its structure, though at a slower rate than the breakdown observed during the ramp-up phase. The area enclosed by the up- and down-curves of the hysteresis loop reflects the energy associated with the breakdown and recovery of the material's microstructure, serving as a preliminary indicator of its thixotropic behavior. As shown in FIGS. 4B and 4C, it is evident that both the PLC and PLC-LF29 systems exhibit minimal thixotropic behavior without CNF. The incorporation of CNF, on the other hand, enhances the thixotropic behavior of the PLC system. However, this effect diminishes with increasing LF replacement. Specifically, in the absence of LF, a substantial rise in thixotropy is observed in PLC-LF0-CNF0.3, whereas, with the addition of LF, the increase is less pronounced. FIG. 3C shows the storage modulus for the PLC and PLC-LF29 systems. By replacing LF with cement at a level of 29% (without CNF), the storage modulus increased by 302%. An increase in storage modulus can indicate the formation of additional or thicker C—S—H links, or a combination of both. This supports the enhanced particle packing filler effects of LF discussed earlier. LF improves the overall packing density and reduces the average spacing between cement particles, which, along with additional nucleation sites for hydration products, leads to a denser and more rigid microstructure. In the PLC system without LF, CNF addition has an insignificant effect on the storage modulus, indicating its limited role in altering the elastic response of the fresh cement matrix under small deformations. However, in the PLC-LF29 system, introducing CNF results in a slight, progressive decrease in storage modulus with increasing CNF dosage. This inverse relationship, when considered alongside the observed increase in static yield stress, suggests that CNF acts primarily through soft colloidal interactions rather than by promoting the formation of rigid hydration products like C—S—H. The reduction in storage modulus implies that CNF may partially interfere with or dilute the rigid network formed by early hydration in the PLC-LF system, weaking the rigid network stiffness even as it increases colloidal structuring.

FIG. 3D presents the results of critical strain measurements, which contribute further insight into the system's internal interactions. Critical strain increased with both CNF addition and LF replacement. When CNF is added, the PLC-CNF0.3 mixture shows a 265.4% improvement in critical strain compared to PLC-CNF0. In the PLC-LF29-CNF0.3 system, the critical strain increases by 542.3% relative to the reference PLC-CNF0 case. Critical strain is associated with the rupture of the rigid network. The observed critical strain values of LF and CNF mixes are substantially higher than those reported for the critical strain values associated with rigid C—S—H networks. This supports the assertion that the enhanced critical strain observed here is more characteristic of soft colloidal networks formed through CNF-CNF and CNF-cement interactions, rather than rigid hydration products. Moreover, since CNF was shown to have a negligible effect on early-age hydration (FIGS. 1C and 1D), the large increase in critical strain is unlikely to be caused by changes in C—S—H formation. Instead, it reflects a distinct colloidal mechanism introduced by CNF that enhances the system's ability to deform and recover.

Thixotropy plays a crucial role in 3DP concrete, improves extrudability during pumping, as the material's temporary reduction in viscosity facilitates smoother flow through the nozzle and reduces the likelihood of clogging or uneven extrusion. A well-balanced thixotropic behavior helps maintain the shape stability of printed layers by allowing the material to recover its yield stress after extrusion, ensuring proper buildability. However, excessive thixotropy can hinder the interlayer bonding, as the rapid stiffening of the material may reduce the adhesion between layers, leading to weaker interfaces and compromising the overall strength of the printed structure. Therefore, controlling thixotropy is crucial for optimizing both the printability and structural performance of 3DP concrete, and CNF can serve as an effective additive to control the thixotropy in 3DP concrete. In addition, the high critical strain may be especially beneficial for printing complex geometries, such as large overhangs, where the material must withstand considerable deformation due to limited support from the underlying layers. Additionally, a higher critical strain helps the material resist unexpected extrusion inconsistencies, which may impose temporary high loads and deformation on the printed layers.

In the field of 3DP concrete, printing geometries with overhangs presents a challenge due to the stringent requirements on rheological properties of the materials. The material formulation containing CNF and LF tested in this study offers a promising solution to address this challenge. A complex hollow column with a 90 mm diameter with approximately a 45-degree overhang was designed to test the performance of different mixtures using a small-scale 3D printer. In this study, as the PLC mixture without CNF and LF demonstrated limited printability, 0.8 wt. % viscosity modifying admixtures (VMA, such as methylcellulose) relative to the weight of the binder materials was incorporated to enhance printability and ensure ink consistency. For consistency in comparison, methylcellulose was included in all mixtures used in this study. FIG. 4D shows the objects printed using different mixtures. For PLC mixture without CNF, the overhang could not be handled, and the structure failed to build up in the third layer due to poor rheological properties. Using the PLC-LF29 mix without CNF, the buildability improved, achieving 12 layers before failure occurred. With the addition of 0.3 wt. % CNF but no LF replacement, the first issue with small-scale syringe printing is the challenge of extrusion due to increased viscosity. To address this, water-reducing admixture (WRA) was added to reduce extrusion pressure. However, the WRA negatively affected other rheological properties, such as static yield stress and critical strain, thereby influencing the buildability. The buildability of this mixture still slightly improved, but bulking failure occurred after 15 layers. For the PLC-LF29-CNF0.3 mix, the synergy between LF and CNF led to successful printing with a buildability of 46 layers without structural failure. The enhanced values of static yield stress, viscosity, and critical strain enabled the mixture to flow without bleeding, and effectively resist the stress from the top layers and the deformation caused by the overhang, leading to the successful printing of the complex structure. More importantly, both CNF and LF are low-cost and low-carbon materials, offering a more economical and sustainable solution to the critical challenge of rheological properties.

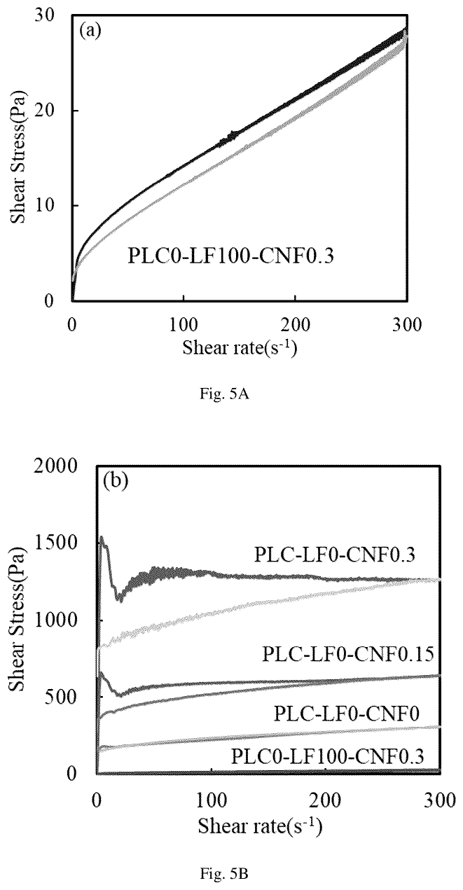

To investigate the interaction between cellulose nano fiber (CNF) and limestone filler (LF), a rheological test was conducted using only LF, water, and CNF, following the same rheological protocol. The water-to-LF ratio was set at 0.4, with a CNF addition of 0.3%. The results of the hysteresis loop test are presented in FIGS. 5A and 5B. The results indicated very low stress throughout the test and significantly lower thixotropy compared to the PLC mixtures containing CNF. Based on these observations, it is assumed that there are no significant interactions between LF and CNF.

### Example 3

### Large Scale 3D Printing Using Robotic Arm

The results presented in the previous section highlight the ability of CNF and LF to improve the rheological properties of the mixes intended for 3D printing. Small-scale 3D printing was used to compare the performance of various mixtures by printing a challenging structure with a large overhang (FIG. 4D). In this section, the CNF-LF mixture at large scale was tested using a robotic arm system to validate its suitability for real-world 3D printing applications. A hollow column with 0.5 m diameter and a 25-degree overhang was developed and illustrated in FIG. 6A. The toolpath algorithm for the robotic arm was developed using Grasshopper. In the case of hollow cylindrical structures with overhangs, buildability is a complex, multi-variable problem that cannot be adequately characterized by a single rheological property. The buildability challenges associated with 3D-printed structures are primarily characterized by two common failure mechanisms: plastic collapse due to yielding of the underlying layers and elastic instability due to buckling of the printed elements. Once yielding is overcome, buckling becomes the dominant failure mode. Yielding failure is primarily governed by yield stress, which represents the material's ability to withstand the load deposited on top of it without flow initiation. In contrast, buckling failure is mainly influenced by stiffness and critical strain. Stiffness, which reflects the material's resistance to deformation under applied force, and critical strain, which indicates the maximum elastic deformation a material can undergo without permanent deformation that compromises the structure's functional geometry, are key factors influencing buckling behavior.

The PLC-LF29-CNF0.3 mixture, which exhibited the most favorable rheological performance, was tested to evaluate its suitability for large scale 3D printing. The printing performance of this formulation was compared with that of two commercially available high-performance mixtures for 3D printing provided by reputable cement manufacturers. As shown in FIG. 6B, the PLC-LF29-CNF0.3 mixture successfully printed 78 layers before the column failed due to buckling. In contrast, FIGS. 6C and 6D illustrate the performance of commercially available high-performance mixtures specifically designed for 3D printing, prepared strictly according to the manufacturers' instructions (17 wt. % water added to the dry material mix). These mixtures did not exhibit optimal performance for printing complex structures. Material from manufacturer #1 demonstrated a buildability of 18 layers, while material from manufacturer #2 achieved only 8 layers before buckling failures. In fact, both commercial mixtures have been used to successfully print regular large-scale elements without any issues, including a 1.5 m tall, curved wall segment, concrete picnic table and benches, and a large-scale slab. While these high-cost commercial materials exhibited sufficient rheological properties for printing such regular structures, they were unable to support the demands of complex geometries with overhangs.

This study underscores the superior performance of the PLC-LF29-CNF0.3 mixture for large-scale 3D printing, surpassing the performance of commercially available materials without requiring accelerators in the formulation. The addition of CNF and LF substantially enhanced the static yield stress, storage modulus, and critical strain, thereby improving the material's capacity to print complex structures. Notably, the synergistic integration of CNF and LF had a moderately low impact on viscosity, ensuring resistance to segregation and bleeding, good pumpability while enhancing other essential rheological properties. Furthermore, the hydration acceleration effect of LF shortened the setting time, resulting in faster stiffening and transition from yield strength to compressive strength. The large-scale robotic arm 3D printing validated the material's readiness for real-world applications.

### Example 4

### Mechanical Properties and Thermogravimetric Analysis (TGA)

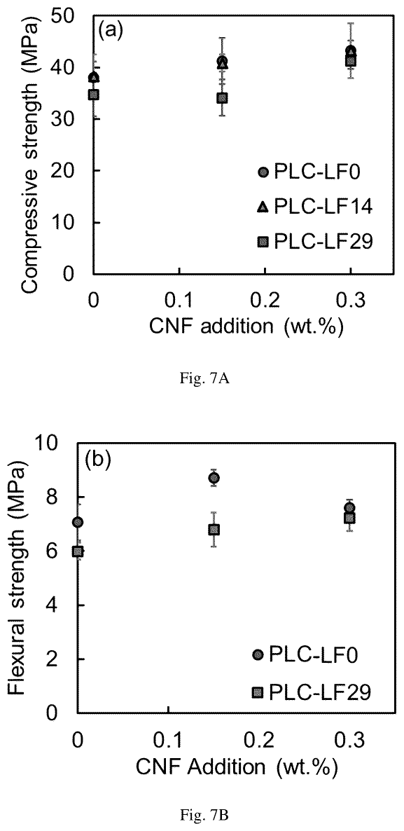

The 28-day compressive strength of cast samples air-cured in the normal lab environment is presented in FIG. 7A. The air curing simulates the environmental conditions typically encountered by 3DP concrete structures in real-life applications. The results indicate that the PLC and PLC-LF14 mixtures demonstrate comparable compressive strengths, suggesting that low levels of LF replacement do not substantially influence the compressive strength. However, the PLC-LF29 mixtures show a reduction in compressive strength compared to the PLC mixtures. This reduction can be attributed to the dilution effect caused by the high level replacement of cement with LF. On the other hand, the addition of CNF leads to an increase in compressive strength. The PLC-LF29-CNF0.3 mixture demonstrates an 18.7% improvement in compressive strength relative to the PLC-LF29-CNF0 mixture. More importantly, the PLC-LF29-CNF0.3 mixture achieves compressive strength comparable to the reference PLC-CNF0 mixture, indicating that the dilution effect from increased LF content is mitigated by the addition of CNF. As a result, the inclusion of CNF enables a total of 40% replacement of cement with LF without compromising compressive strength, lowering both material costs and the carbon footprint. FIG. 10 shows the normalized compressive strength—defined as the compressive strength per unit volume of cement—plotted against the cement volume fraction in the mixtures. This metric reflects the efficiency of cement utilization, with the cement volume fraction decreasing due to partial replacement by limestone filler (LF). The results indicate that greater strength per unit volume of cement (i.e., normalized compressive strength increases as the cement volume fraction decreases) can be achieved when less cement is used in the mixture. When cellulose nanofiber (CNF) is incorporated into the mixture, the normalized compressive strength is further increased. Thus, the synergistic combination of CNF and LF not only reduces the total cement content but also enhances cement utilization efficiency, thereby improving the cost-effectiveness and sustainability of the mixtures.

FIG. 7B presents the 7-day flexural strength of 3D printed mortar beams under air-cured conditions in the normal lab environment. Consistent with the compressive strength results, the PLC-LF29 mixtures exhibit reduced flexural strength compared to the PLC mixtures, due to the dilution effect from replacing cement with limestone filler. However, the addition of 0.3 wt % CNF brings the flexural strength of the PLC-LF29 mixture to a level comparable to that of the reference mixture without LF replacement.

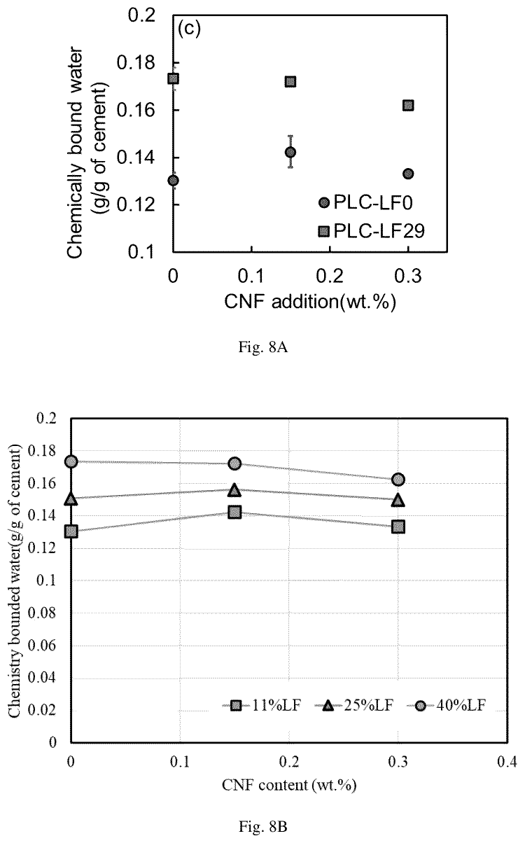

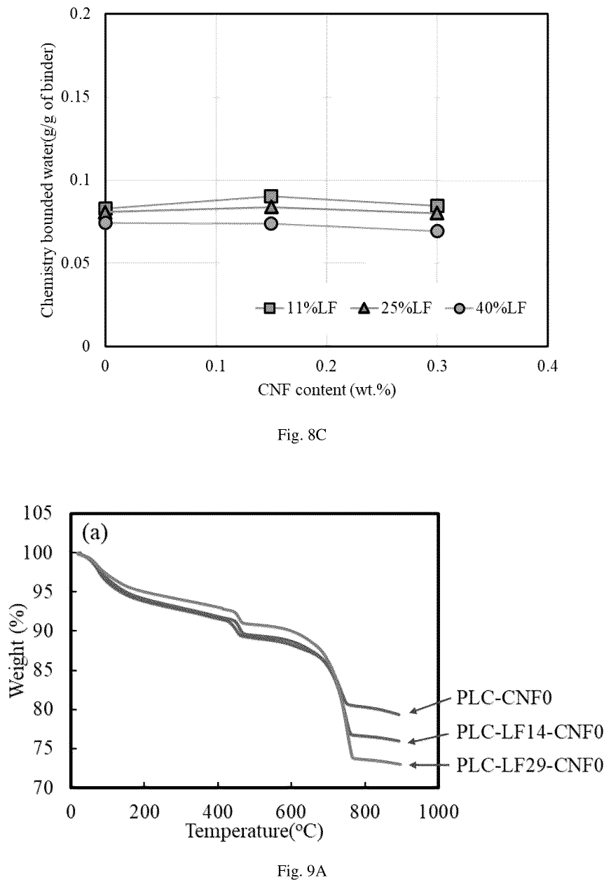

Thermogravimetric analysis (TGA) was used to investigate the mechanism behind the improvement in mechanical properties due to CNF addition. The TGA assessed the hydration kinetics of the cement-CNF-LF mixture air-cured in the lab. FIGS. 8A-8C show the chemically bound water content (i.e., hydration) in the samples after 28 days of curing. The results indicate an increase in chemically bound water per gram of cement with the replacement of cement by LF, suggesting that LF enhances the hydration process. However, despite the increase in the amount of chemically bound water per gram of cement (FIGS. 8A and 8B), the compressive strength of the PLC-LF29 mixtures remains lower than that of the PLC system. This is due to the high level of LF replacement, which reduces the overall cement content in the system. The addition of CNF slightly increases the chemically bound water at an addition of 0.15 wt. %, while a decrease is observed at 0.3 wt. %. Nonetheless, both compressive and flexural strengths values generally increased with higher CNF addition. This implies that the strength enhancement provided by CNF is not primarily related to its influence on cement hydration, but rather it is due to CNF's ability to bridge micro-pores and cracks within the material, thereby improving its mechanical properties.

### Example 5

### Environmental and Economic Impacts

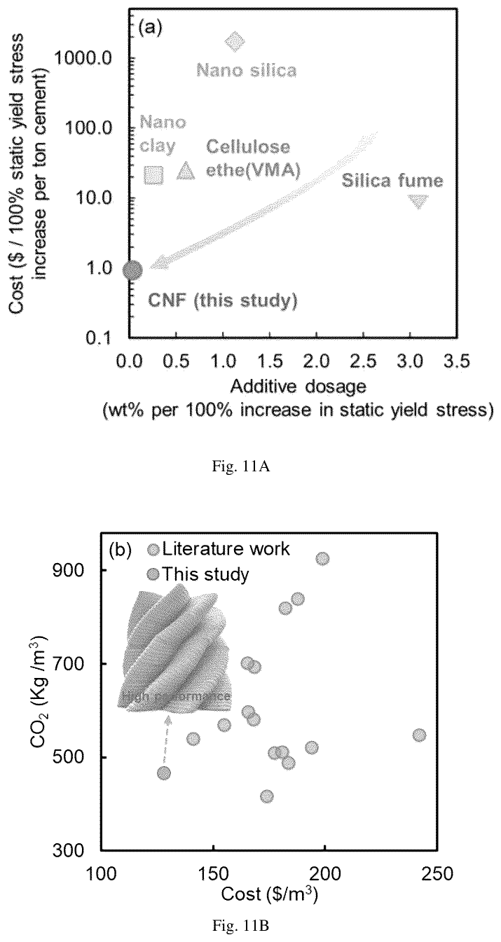

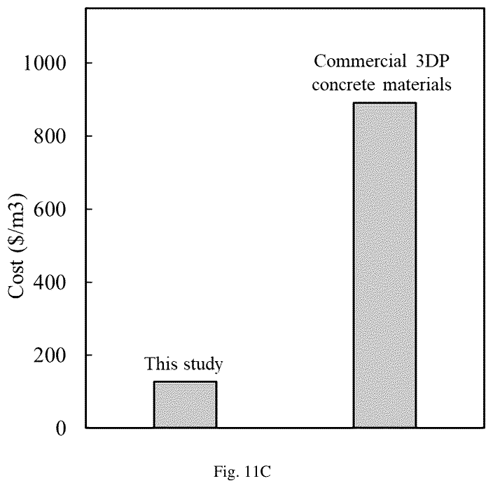

The current 3DP concrete faces persistent challenges due to its high carbon footprint and elevated costs, primarily driven by the large volume of cement and extensive use of additives required to achieve desirable performance. It is advantageous to reduce the carbon footprint and material cost when considering large-scale construction. In this example, a systematic evaluation was conducted of both the environmental and economic impacts of the materials developed in this study, comparing them with materials for 3D printing reported in the literature. FIG. 11A highlights a comparative analysis of the effectiveness and cost of CNF relative to other additives. Since static yield strength is an important property for 3D printing applications, the comparison focuses on the dosage required to achieve a 100% increase in static yield stress across different additives. The results show that CNF is the most efficient additive, requiring only 0.04% by weight of the binder to produce a 100% increase in static yield stress. In contrast, higher dosages are required for other additives: 0.27% for nanoclay, 0.60% for cellulose ether (a type of viscosity-modifying admixture for cement), 3.11% for silica fume, and 1.13% for nanosilica. From a cost perspective, CNF also is the most economical option. Enhancing the static yield stress by 100% with CNF costs only $0.92 per ton of cement, compared to $20.80 for nanoclay, $25.20 for cellulose ether, $8.93 for silica fume, and $1748.12 for nanosilica.

In addition to improvements in rheological properties, the environmental benefits of the PLC-LF29-CNF0.3 mixture developed in this example are evident. FIG. 11B compares the carbon footprint and material cost of this mixture with those reported in previous studies. The proposed mixture demonstrates a 32.7% reduction in carbon footprint and a 40.0% decrease in material cost compared to the average values of mixtures for 3D printing reported in the literature (based on data from 15 studies). More notably, those previous studies did not demonstrate the capability to print complex structures with overhangs. The material in this example demonstrates an effective reduction in carbon emissions and material cost while simultaneously enhancing rheological and mechanical performance, as well as enabling the printing of complex overhang structures—a capability not achieved in existing studies. In addition, when compared with commercial high-performance 3D-printed concrete, the mixture described herein offers superior buildability for printing overhang structures and is approximately seven times more cost-effective than the market price of commercial 3D-printed concrete materials (FIG. 11C). In conclusion, CNF is an effective and low carbon, low-cost additive for enhancing the rheological properties of 3DP concrete while simultaneously improving its mechanical performance. Moreover, the synergy between CNF and LF may enhance performance while addressing the environmental and economic challenges of the 3DP concrete industry.

Table 2 presents data collected from the literature, including the cost, CO₂ emissions, and dosage required for a 100% improvement in static yield strength for various materials. These data were used to calculate the results presented in FIG. 11A, which compare the effectiveness and cost of CNF with other materials. For the results presented in FIG. 11B, the carbon footprint and cost of the mixtures are calculated by integrating the values of each individual ingredient with the corresponding mix proportions. Table 3 provides the calculated carbon footprints and costs of 3D printing concrete mixtures reported in previous studies.

TABLE 2
Cost, CO₂ emissions, and dosage required for a 100% improvement
in static yield strength for the materials.

| | | | Dosage needed |
|---|---|---|---|
| | | | for 100% static |
| | | | yield strength |
| Materials | Cost ($/Kg) | CO₂ (Kg/Kg) | improvement (%) |
| CNF** | 2.440 | 4.200 | 0.038 (this study) |
| OPC** | 0.155 | 0.820 | / |
| LF** | 0.043 | 0.016 | / |
| PLC** | 0.143* | 0.749* | / |
| Silica fume | 0.350 | 0.025 | 3.106 |
| Slag | 0.150 | 0.026 | / |
| CSA cement | 0.248 | 0.644 | / |
| Fly ash | 0.078 | 0.027 | / |
| Coarse aggregate | 0.023 | 0.041 | / |
| Sand | 0.026 | 0.014 | / |
| Cellulose ether | 4.170 | 3.69 | 0.600 |
| Superplasticizers | 1.667 | 1.211 | / |
| Nanoclay | 7.800 | / | 0.267 |
| Nanosilica | 155.00 | / | 1.128 |

*The CO₂ emissions and cost of PLC were calculated based on the values for OPC and LF, considering the composition of 89% OPC and 11% LF.
**materials used in the present disclosure

TABLE 3
Cost and carbon footprint of 3D printing
concrete mixtures previously reported.

| Ex. | Binder materials | CO₂ (Kg/m³) | Cost ($/m³) |
|---|---|---|---|
| 1 | Cement | 819.3 | 182.4 |
| 2 | Cement, fly ash | 581.1 | 168.2 |
| 3 | Cement, silica fume | 597.7 | 165.8 |
| 4 | Cement | 693.4 | 168.5 |
| 5 | CSA cement | 548.3 | 242.0 |
| 6 | Cement | 539.2 | 141.2 |
| 7 | Cement | 925.0 | 199.0 |
| 8 | Cement | 701.5 | 165.3 |
| 9 | Cement, fly ash, | 508.5 | 177.3 |
| | silica fume | | |
| 10 | Cement, fly ash, | 521.1 | 193.9 |
| | silica fume | | |
| 11 | Cement, fly ash, | 511.1 | 181.0 |
| | silica fume | | |
| 12 | Cement | 839.6 | 187.7 |
| 13 | Cement, slag | 416.4 | 173.8 |
| 14 | Cement, fly ash, | 488.4 | 183.8 |
| | silica fume | | |
| 15 | Cement, fly ash | 596.7 | 154.9 |

The proposed mixture (PLC-LF29-CNF0.3) was further compared with commercial high-performance 3D-printed concrete materials (FIG. 11C), which have been demonstrated to print regular structures but not overhang structures. The material cost of the proposed mixture offers superior buildability and is approximately seven times more cost-effective than the market price of the commercial materials. The price of the commercial materials is based on recent quotes from two reliable cement manufacturing companies.

### Example 6

The results described herein contribute to the advancement of material development for 3D-printed concrete by addressing critical challenges related to rheology, mechanical properties, sustainability, and cost-efficiency. Conventional additives often increase yield stress at the expense of higher viscosity, creating a trade-off between pumpability and buildability. In contrast, the synergistic effect of CNF and LF overcomes this limitation, resulting in a material that combines high buildability (through increased yield strength, storage modulus, and critical strain) with moderately low viscosity for enhanced pumpability. The results described herein demonstrate that the incorporation of 0.3 wt. % CNF results in a 903% improvement in static yield stress, along with more than an approximately 20% increase in both compressive and flexural strengths compared to the reference case without CNF. Moreover, the synergistic effect of 0.3 wt. % CNF with 29% LF replacement increases static yield stress, storage modulus, and critical strain by 1213%, 255%, and 542%, respectively. Simultaneously, the influence on viscosity is reduced from 303% (with 0.3 wt. % CNF alone) to 138% (with 0.3wt. % CNF and 29% LF). This breakthrough in rheological control paves the way for practical and efficient printable materials, establishing the CNF-LF system as a superior alternative to current 3DP mixtures.

These results demonstrate that CNF is the most effective and cost-efficient additive among those studied in previous research, such as nano-clay, cellulose ether, silica fume, and nano-silica, offering an optimal balance between performance, sustainability, and cost efficiency. The incorporation of only 0.3% CNF results in a nine-fold improvement in static yield stress, along with an approximately 20% increase in both compressive and flexural strengths. These enhancements in mechanical properties effectively mitigate the dilution effect caused by high levels of cement replacement with LF. Furthermore, this mixture formulation stands out for its sustainability, achieving these performance benefits while reducing the cost and carbon footprint by 40% and 32.7%, respectively, compared to the average values of mixtures for 3D printing reported in the literature. Lastly, the material's readiness for real-world applications was validated by demonstrating its large-scale construction feasibility using robotic arm 3D printing. Overall, the combination of CNF and LF positions it as a promising, sustainable solution to the challenges faced in the field of 3D-printed concrete.

The broader impact of this research extends beyond 3D-printed concrete, contributing to the wider construction industry and its sustainability efforts. By utilizing CNF—a natural material—this study introduces a more sustainable approach to enhancing concrete performance. These innovations not only advance the practical applications of 3D-printed concrete but also promote more sustainable construction practices. The high performance, cost-effectiveness, and reduced environmental impact of the material underscore its readiness for real-world implementation in large-scale construction and promote the broader adoption of 3D printing technologies in the construction industry.

1. A composition comprising:
a binder comprising a cementitious material and limestone, wherein the binder comprises at least 15% limestone by weight of the binder, and
a plurality of cellulose nanofibers (CNFs),
wherein the composition comprises about 0.01% to about 1% CNFs by weight relative to the binder.

2. The composition of claim 1, wherein the binder comprises about 20% to about 60% limestone by weight of the binder.

3. The composition of claim 1, wherein the composition comprises water, and the water is present at a ratio (wt./wt.) of water to the binder of about 0.1 to about 1.0.

4. The composition of claim 1, wherein the composition comprises sand, and the sand is present at a ratio (wt./wt.) of sand to the binder of about 0.5 to about 2.

5. The composition of claim 1, wherein the cementitious material is selected from the group consisting of cement, slag, fly ash, silica fume, and any combination thereof.

6. The composition of claim 1, wherein the cementitious material comprises about 1% to about 25% limestone by weight of the cementitious material.

7. The composition of claim 1, wherein the composition has
a static yield stress of greater than 500 Pa,
a storage modulus of greater than 50 kPa,
a critical strain of greater than 0.05%, or
any combination thereof.

8. The composition of claim 1, wherein the composition has a viscosity of about 0.2 Pa·s to about 1.5 Pa·s.

9. The composition of claim 1, wherein the composition does not comprise an accelerator.

10. A mortar comprising:
the composition according to claim 1,
sand, and
water.

11. The mortar of claim 10, wherein the mortar has a compressive strength of greater than 30 MPa, and a flexural strength of greater than 5 MPa.

12. A multilayer structure comprising:
a first layer and a second layer arranged to be in contact with the first layer,
wherein each of the first layer and the second layer independently comprises:
the composition according to claim 1,
sand, and
water.

13. The multilayer structure of claim 12, wherein the second layer forms an overhang of at least 5 degrees relative to the first layer.

14. A method of making a structure, the method comprising the steps of:
extruding a mortar through an extruder to provide an extrudate,
wherein the mortar comprises:
a binder comprising a cementitious material and limestone,
a plurality of cellulose nanofibers (CNFs),
sand, and
water; and
depositing the extrudate onto a surface to provide the structure.

15. The method of claim 14, further comprising a step of mixing, wherein the step of mixing comprises combining the binder comprising the cementitious material and limestone, the plurality of cellulose nanofibers (CNFs), sand, and water to provide the mortar.

16. The method of claim 14, further comprising a step of transferring the mortar through a pump to the extruder, wherein the extruder is fluidly coupled to the pump.

17. The method of claim 14, further comprising a step of one of
(i) moving the extruder,
(ii) moving the surface, or
(iii) independently moving the extruder and the surface,
wherein (i), (ii), or (iii) independently move in a direction to provide the structure.

18. The method of claim 14, wherein the method excludes a step of adding an accelerator to the composition, mortar, or extrudate.

19. The method of claim 14, wherein the step of depositing comprises depositing the extrudate onto the surface to provide a first layer of the structure, and depositing the extrudate onto the first layer of the structure to provide a second layer of the structure in contact with the first layer.

20. The method of claim 19, wherein the second layer forms an overhang of at least 5 degrees relative to the first layer.
